(19) United States
(12) Patent Application Publication
(10) Pub. No.: US 2024/0014424 A1
(43) Pub. Date: Jan. 11, 2024

(54) ELECTROLYTE MEMBRANE FOR MEMBRANE-ELECTRODE ASSEMBLY WITH HIGH DURABILITY

(71) Applicants: Hyundai Motor Company, Seoul (KR); Kia Corporation, Seoul (KR); INDUSTRY FOUNDATION OF CHONNAM NATIONAL UNIVERSITY, Gwangju (KR)

(72) Inventors: In Yu Park, Seoul (KR); Jong Kil Oh, Yongin (KR); Sun Ju Song, Seoul (KR); Jae Woon Hong, Jeollanam-Do (KR); Aniket Kumar, Gwangju (KR); Ye Jin Yun, Suncheon (KR)

(21) Appl. No.: 18/084,263

(22) Filed: Dec. 19, 2022

(30) Foreign Application Priority Data
Jul. 7, 2022 (KR) 10-2022-0083459

(51) Int. Cl. H01M 8/1046; H01M 8/1004; H01M 8/1039; H01M 8/1032; H01M 8/1027; H01M 8/1072; C07F 7/22

(52) U.S. Cl. CPC H01M 8/1046; H01M 8/1004; H01M 8/1039; H01M 8/1032; H01M 8/1027; H01M 8/1072; C07F 7/2284; H01M 2008/1095

(57) ABSTRACT

Disclosed are an electrolyte membrane with excellent durability resulting from the inclusion of a metal-organic framework (MOF), and a membrane-electrode assembly including the same. The electrolyte membrane may include an ionomer; and metal-organic frameworks (MOFs) in which a first metal ion and an organic ligand are coordinated.

### CROSS-REFERENCE TO RELATED APPLICATION

This application claims under 35 U.S.C. § 119(a) the benefit of priority to Korean Patent Application No. 10-2022-0083459 filed on Jul. 7, 2022, the entire contents of which are incorporated herein by reference.

### TECHNICAL FIELD

The present disclosure relates to an electrolyte membrane with excellent durability resulting from the inclusion of a metal-organic framework (MOF), and to a membrane-electrode assembly including the same.

### BACKGROUND

A polymer electrolyte membrane fuel cell is a device generating electricity through an electrochemical reaction between hydrogen and oxygen, and has a high power generation efficiency without emissions other than water. Additionally, the polymer electrolyte membrane fuel cell generally operates at a temperature of 95° C. or less and has a high power density.

The electrochemical reaction of the fuel cell takes place in a membrane-electrode assembly (MEA) constituted with an electrolyte membrane containing a perfluorinated sulfonic acid-based ionomer, and an anode and cathode electrodes. After hydrogen supplied to the anode, which is the oxidation electrode, is separated into hydrogen ions (protons) and electrons, the hydrogen ions move toward the cathode, which is the reduction electrode, through the electrolyte membrane, and the electrons move to the cathode through an external circuit. In the cathode, oxygen molecules, hydrogen ions, and electrons react together to generate electricity and heat, and water (H2O) is produced as a reaction by-product.

The electrolyte membranes including perfluorinated sulfonic acid ionomer (PFSA) have high proton conductivity, and excellent performance and stability under various humidification conditions, so that they have been widely used in polymer electrolyte membrane fuel cells. However, the electrolyte membrane including the perfluorine sulfonic acid-based ionomer has a drawback in that it is thermally degraded at a temperature of 100° C. or higher, which leads to the abrupt reduction in its hydrogen ion conductivity, mechanical properties, and dimensional stability.

Meanwhile, hydrogen and oxygen, which are reactive gases of the fuel cell, crossover through the electrolyte membrane to promote the production of hydrogen peroxide (HOOH). The hydrogen peroxide produces oxygen-containing radicals such as a hydroxyl radical (OH), a hydroperoxyl radical (•OOH), and the like. The radicals attack the electrolyte membrane, causing chemical degradation of the membrane, and eventually lowering the durability of the fuel cell.

In the related art, a method for mitigating chemical deterioration of the electrolyte membrane by adding an antioxidant has been introduced. Examples of the antioxidant include a primary antioxidant which is a radical scavenger and a secondary antioxidant which is a hydrogen peroxide decomposer. In addition, examples of the primary antioxidant includes cerium-based antioxidants, such as cerium oxide, cerium nitrate hexahydrate, and the like, terephthalic acid-based antioxidants, and the like. Examples of the secondary antioxidant include manganese-based antioxidants such as manganese oxide and the like.

Conventionally, antioxidants such as cerium (III) nitrate hexahydrate were used frequently, and, however, there is a problem in that the cerium ion binds to the sulfonic acid group terminal of the perfluorinated sulfonic acid-based ionomer, and blocks the path through which hydrogen ions (H⁺) can move, thereby reducing the proton conductivity of the electrolyte membrane.

### SUMMARY

In preferred aspects, provided are an electrolyte membrane with excellent chemical durability and a membrane-electrode assembly including the same.

The objectives of the present disclosure are not limited to the one mentioned above. The objective of the present disclosure will become further apparent by the following description, and will be realized by means and combinations thereof recited in the claims.

In an aspect, provided is an electrolyte membrane for a membrane-electrode assembly that may include an ionomer; and metal-organic frameworks (MOFs) in which a first metal ion and an organic ligand are coordinated.

The term “ionomer” as used herein refers to a polymeric material or resin that includes ionized groups attached (e.g., covalently bonded) to the backbone of the polymer as pendant groups. Preferably, such ionized groups may be functionalized to have ionic characteristics, e.g., cationic or anionic.

The ionomer may suitably include one or more polymers selected from the group consisting of a fluoro-based polymer, a perfluorosulfone-based polymer, a benzimidazole-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, a polyphenylquinoxaline-based polymer and a polystyrene-based polymer.

The term “metal-organic framework (MOF)” as used herein refers to a compound or complex including one or more metal ions and organic ligands coordinated to the metal ions to form one-, two-, or three-dimensional structures.

The ionomer may include a perfluorinated sulfonic acid-based polymer.

The first metal ion may include tin ions (Sn²⁺), zinc ions (Zn²⁺), manganese ions (Mn²⁺), and combinations thereof.

The organic ligand may include an imidazole-based compound.

The term “imidazole-based compound” as used herein refers to a compound having one or more imidazole groups, which may be connected via linkers (e.g., covalent bond linker, ionic bond linker, or metallic bond linkers). In certain embodiments, four imidazole groups are linked via metal ions (e.g., first metal) to form a MOF.

The metal-organic framework may be represented by Formula 1 below:

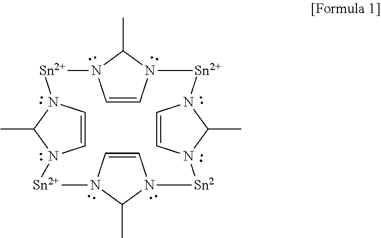

The metal-organic framework may further include a second metal ion located in an inner space of the metal-organic framework.

The second metal ion may include trivalent cerium ions (Ce³⁺), tetravalent cerium ions (Ce⁴⁺), and combinations thereof.

A weight ratio of the first metal ion and the second metal ion may be from about 1:1 to 20:1.

The metal-organic framework may be represented by Formula 2 below:

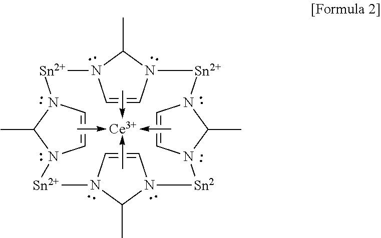

The electrolyte membrane may include the metal-organic framework in an amount of 0.01 wt % to 20 wt % based on the total weight of the electrolyte membrane.

In an aspect, provided is a method for preparing an electrolyte membrane for a membrane-electrode assembly. The method may include preparing a first solution including a precursor of a first metal ion, preparing a second solution including a precursor of an organic ligand, obtaining an admixture including the first solution and the second solution, agitating the admixture to precipitate a metal-organic framework in which the first metal ion and the organic ligand are coordinated, preparing a dispersion including the ionomer and the metal-organic framework, and preparing an electrolyte membrane by applying the dispersion on a substrate.

The metal-organic framework may be precipitated by agitating the admixture at a temperature of about 50° C. to 150° C. for about 1 hour to 24 hours.

A third solution including a precursor of a second metal ion may be added to the admixture and agitated to precipitate a metal-organic framework. Preferably, the inner space of the metal-organic framework may include the second metal ion. In other words, the second metal ion may form a coordination with electron pairs of imidazoles of the MOF.

Also provided is a fuel cell including the electrolyte membrane as described herein.

Further provided is a vehicle including the fuel cell described herein.

According to various exemplary embodiments of the present disclosure, an electrolyte membrane having excellent chemical durability and a membrane-electrode assembly including the same can be obtained.

Other aspects of the invention are disclosed infra.

### BRIEF DESCRIPTION OF THE DRAWINGS

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 shows an exemplary membrane-electrode assembly according to an exemplary embodiment of the present disclosure;

FIG. 2 shows a result of analyzing the specific surface area of the metal-organic framework according to Preparation Example 2; and

FIG. 3 shows a result of analyzing fluoride ion emissions of the electrolyte membranes according to Examples 1, 2 and Comparative Example.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in section by the particular intended application and use environment.

In the figures, reference numbers refer to the same or equivalent sections of the present disclosure throughout the several figures of the drawing.

### DETAILED DESCRIPTION

The aforementioned objectives, other objectives, features and advantages of the present disclosure will be easily understood through the following preferred embodiments in conjunction with the accompanying drawings. However, the present disclosure is not limited to the embodiments described herein, but may be embodied in other forms. Rather, the embodiments introduced herein are provided so that the disclosed contents may be thorough and complete, and the technical idea of the present disclosure may be sufficiently conveyed to those skilled in the art.

At the time of describing respective drawings, like reference numerals have been used for like components. In the accompanying drawings, the dimensions of the structures are enlarged from reality for clarity of the present disclosure. Terms, such as “first” and “second,” can be used to describe various components, but the components should not be limited by the terms. Said terms are used in order only to distinguish one component from another component. For example, the first component can be designated as the second component without departing from the scope of the present disclosure, and, similarly, the second component can also be designated as the first component. Singular expressions may include the meaning of plural expressions unless the context clearly indicates otherwise.

The terms such as “include (or comprise)”, “have (or be provided with)”, and the like are intended to indicate that features, numbers, steps, operations, components, parts, or combinations thereof written in the following description exist, and thus should not be understood as that the possibility of existence or addition of one or more different features, numbers, steps, operations, components, parts, or combinations thereof is excluded in advance. Also, when it is stated that a portion of a layer, film, region, plate, or the like is “on” another portion, it includes not only the case where it is “directly on” another portion, but also the case where other portion is interposed therebetween. Conversely, when it is stated that a portion of a layer, film, region, plate, or the like is “under” another portion, it includes not only the case where it is “directly under” another portion, but also the case where other portion is interposed therebetween.

Unless otherwise specified, all numbers, values and/or expressions used herein to express quantities of ingredients, reaction conditions, polymer compositions and compounds are to be understood as being modified in all instances by the term “about”, since, among others, these numbers are essentially approximations which reflect the varying uncertainties of the measurements that take place in obtaining these values. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Also, when numerical ranges are disclosed in this description, such ranges are continuous and include all values between the minimum and the maximum (inclusive) of the ranges, unless otherwise indicated. Furthermore, when such ranges refer to integers, all integers between the minimum and the maximum (inclusive) are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 25.5%, and the like.

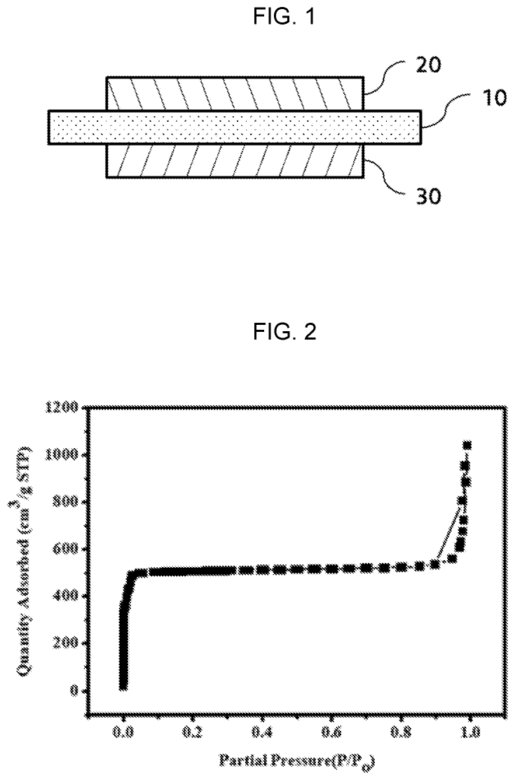

FIG. 1 shows a membrane-electrode assembly according to an exemplary embodiment of the present disclosure. The membrane-electrode assembly may include an electrolyte membrane 10, a cathode 20 positioned on one surface of the electrolyte membrane 10, and an anode 30 positioned on the other surface of the electrolyte membrane 10.

The cathode 20 and the anode 30 may include a catalyst in which an active metal is supported on a support, and a binder.

The kind of the support is not particularly limited, and may include, for example, at least one selected from the group consisting of carbon black, carbon nanotube, graphite, graphene, carbon fiber, carbon nanowire, and combinations thereof.

The kind of the active metal is not particularly limited, and may include, for example, a noble metal such as platinum (Pt), palladium (Pd), iridium (Ir), ruthenium (Ru), or the like. Additionally, the active metal may further include a transition metal such as copper (Cu), cobalt (Co), nickel (Ni), iron (Fe), or the like. The active metal may include a mixture of the noble metal and the transition metal or an alloy thereof.

The binder is a component that imparts adhesion to the catalyst, and may include a polymer with hydrogen ion conductivity. For example, it may include a perfluorinated sulfonic acid-based polymer such as Nafion or the like.

The electrolyte membrane 10 may include an ionomer and metal-organic frameworks (MOF s).

The ionomer may include a perfluorinated sulfonic acid-based polymer such as Nafion or the like.

The metal-organic framework (MOF) may impart antioxidant properties to the electrolyte membrane 10. The metal-organic framework (MOF) may be one in which a first metal ion and an organic ligand are coordinated.

The metal-organic framework (MOF) may include a crystalline material in which the first metal ions are connected through an organic ligand serving as a linker to form a framework having a constant inner space.

The first metal ion may include at least one selected from the group consisting of tin ions (Sn²⁺), zinc ions (Zn²⁺), manganese ions (Mn²⁺), and combinations thereof. The first metal ion serves as an inorganic scavenger.

The organic ligand may include an imidazole-based compound. For example, the imidazole-based compound may include 2-methyl imidazole. The organic ligand serves as an organic scavenger.

Particularly, the metal-organic framework (MOF) may include a compound represented by Formula 1 below.

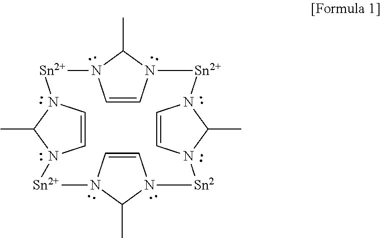

The metal-organic framework (MOF) may further include a functionalized second metal ion in an inner space of the framework. Here, “functionalized” may mean filling the inside of the framework or connected through a chemical bond or an electrochemical interaction with an element or a bond between the elements constituting the inner space.

The second metal ion may include at least one selected from the group consisting of trivalent cerium ions (Ce³⁺), tetravalent cerium ions (Ce⁴⁺), and combinations thereof. The second metal ion serves as an inorganic scavenger together with the first metal ion.

A weight ratio of the first metal ion and the second metal ion may be from about 1:1 to about 20:1. When the weight ratio is greater than about 20:1, the effect of increasing the antioxidant properties resulting from the addition of the second metal ion may be insignificant. When the weight ratio is less than about 1:1, an excess of the second metal ions may be in the form of an oxide without binding to the inner space of the metal-organic framework (MOF).

The metal-organic framework (MOF) including the second metal ion may include a compound represented by Formula 2 below.

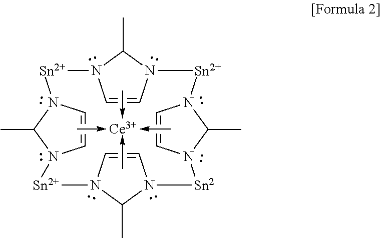

The electrolyte membrane 10 may include an amount of about 80 wt % to 99.99 wt % of the ionomer and an amount of about 0.01 wt % to 20 wt % of the metal-organic framework (MOF) based on the total weight of the electrolyte membrane. When the content of the metal-organic framework (MOF) is less than about 0.01 wt %, the antioxidant property of the electrolyte membrane 10 may not be increased, while, when it is greater than about 20 wt %, the hydrogen ion conductivity of the electrolyte membrane 10 may be decreased.

The method for preparing an electrolyte membrane for a membrane-electrode assembly may include preparing a first solution including a precursor of a first metal ion, preparing a second solution including a precursor of an organic ligand, obtaining an admixture including the first solution and the second solution, agitating the admixture to precipitate a metal-organic framework in which the first metal ion and the organic ligand are coordinated, preparing a dispersion including the ionomer and the metal-organic framework, and preparing an electrolyte membrane by applying the dispersion on a substrate.

The precursor of the first metal ion is not particularly limited, and may include an appropriate one in accordance with the condition such as the kind of a solvent, a preparing apparatus, or the like. The precursor of the first metal ion may include a hydrate, halide or the like of the first metal ion. For example, the precursor of the first metal ion may include tin chloride (SnCl₂).

The precursor of the organic ligand is not particularly limited, and may include an appropriate one in accordance with the condition such as the kind of a solvent, a preparing apparatus, or the like. The precursor of the organic ligand may include imidazole, a derivative of imidazole, and the like. For example, the precursor of the organic ligand may include 2-methyl imidazole.

The first solution and/or the second solution may further include an additive for controlling a two-dimensional shape, dispersibility, or the like of the metal-organic framework. For example, the additive may include polyvinylpyrrolidone. The amount of the additive is not particularly limited, and may be 10 parts by weight to 500 parts by weight, or 100 parts by weight to 200 parts by weight based on 100 parts by weight of the first metal ion.

The first solution and the second solution may include an aqueous solvent or an organic solvent. The organic solvent is not particularly limited, and may include, for example, an alcohol-based solvent such as methanol, ethanol, propanol, or the like.

The metal-organic framework may be precipitated by agitating the admixture obtained by mixing the first solution and the second solution.

The admixture may be agitated at a temperature of about 50° C. to 150° C. for about 1 hour to 24 hours. When the agitating temperature is less than about 50° C. or the agitating time is shorter than 1 hour, the reaction may not occur or the metal-organic framework may not be sufficiently precipitated. When the agitating temperature is greater than about 150° C., the precursors may be deteriorated. When the agitating time exceeds 24 hours, the amount of metal-organic frameworks precipitated no longer increases, and thus productivity may decrease.

The metal-organic framework obtained as described above may include the compound represented by Formula 1 above.

Meanwhile, a third solution including a precursor of a second metal ion may be added to the mixed solution, and agitated under the above-described conditions to precipitate a metal-organic framework represented by Formula 2 above.

The precursor of the second metal ion is not particularly limited, and may include an appropriate one in accordance with the condition such as the kind of a solvent, a preparing apparatus, or the like. The precursor of the second metal ion may include a hydrate, halide, nitride, or the like of the second metal ion. For example, the precursor of the first metal ion may include cerium nitrate (Ce(NO₃)₃).

The metal-organic framework obtained as described above may be added to the ionomer solution to obtain a dispersion, and the dispersion may be applied on a substrate to prepare an electrolyte membrane. The coating method and amount of the dispersion are not particularly limited, and may be any coating method and amount usually used in the technical field to which the present disclosure pertains.

### EXAMPLE

The present disclosure will be described in more detail with reference to the following examples. However, the following examples are merely examples to help the understanding of the present disclosure, and the scope of the present disclosure is not limited thereto.

### Preparation Example 1

Solution A was prepared by dissolving tin chloride (SnCl₂) in 40 ml of methanol. Solution B was prepared by dissolving polyvinylpyrrolidone (PVP) and 2-methyl imidazole in 40 ml of methanol. An admixture was prepared by mixing solution A and solution B so that the weight ratio of tin ions (Sn²⁺), polyvinylpropylene, and 2-methyl imidazole was 1:2:8.

The admixture was agitated at about 100° C. for about 24 hours, and the precipitated particles were separated to obtain a powder. The powder was washed three times with distilled water to remove impurities, and dried sufficiently in an electric oven at a temperature of about 80° C. to obtain a metal-organic framework (MOF) represented by Formula 1 above.

### Preparation Example 2

Solution A was prepared by dissolving tin chloride (SnCl₂) in 40 ml of methanol. Solution B was prepared by dissolving polyvinylpyrrolidone (PVP) and 2-methyl imidazole in 40 ml of methanol. An admixture was prepared by mixing solution A and solution B so that the weight ratio of tin ions (Sn²⁺), polyvinylpropylene, and 2-methyl imidazole was 1:2:8, and by agitating the same for about 1 hour.

Solution C was prepared by dissolving cerium nitrate (Ce(NO₃)₃) in 40 ml of methanol. The admixture and solution C were mixed to obtain a reaction solution. When solution A and solution B were first mixed and agitated to cause a reaction, and then solution C was added, the cerium element was functionalized in the inner space after the metal-organic framework composed of the tin ion and 2-methyl imidazole is formed, and so a compound represented by Formula 2 could be prepared more effectively. However, the present disclosure is not limited to the metal-organic framework prepared by the above-described preparing method because the intended compound can be formed even when solution A, solution B, and solution C are mixed together. That is, the time when solution C is mixed is not particularly limited.

The reaction solution was agitated at a temperature of about 100° C. for about 24 hours, and the precipitated particles were separated to obtain a powder. The powder was washed three times with distilled water to remove impurities, and dried sufficiently in an electric oven at about 80° C. to obtain a metal-organic framework (MOF) represented by Formula 2 above.

FIG. 2 is a result of analyzing the specific surface area of the metal-organic framework according to Preparation Example 2. As shown in FIG. 2, metal-organic framework had a high specific surface area of about 1,500 m²/g. Considering that it would be difficult for the specific surface area of a typical nanopowder to exceed 300 m²/g, the metal-organic framework has a very wide specific surface area.

### Example 1

A dispersion was prepared by adding Nafion to a mixed solvent of distilled water and alcohol. The metal-organic framework according to Preparation Example 1 was added as an antioxidant to and mixed with the dispersion. The resultant was applied on a substrate and dried, so that an electrolyte membrane was prepared.

### Example 2

An electrolyte membrane was prepared in the same manner as in Example 1, except that the metal-organic framework according to Preparation Example 2 was added as an antioxidant.

### Comparative Example

An electrolyte membrane was prepared in the same manner as in Example 1, except that no antioxidant was added.

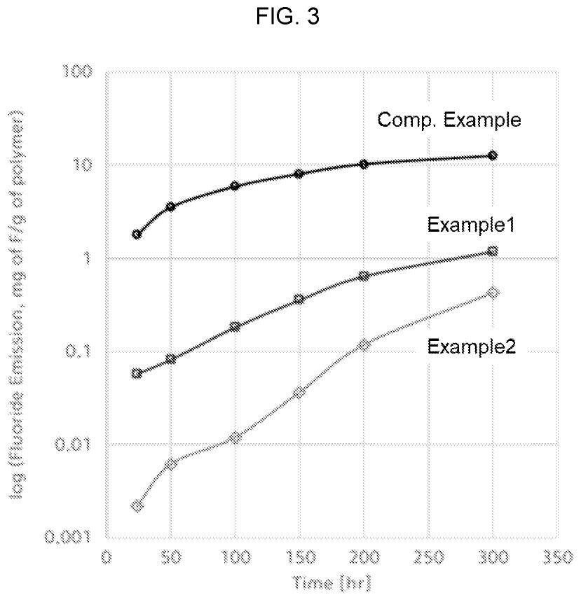

FIG. 3 shows a result of analyzing fluoride ion emissions of the electrolyte membranes according to Examples 1, 2 and Comparative Example. The fluoride ion emissions were measured by reacting each electrolyte membrane while being immersed in Fenton Solution.

As shown in FIG. 3, the electrolyte membranes of Examples 1 and 2 exhibited reduced fluoride ion emissions compared to that of Comparative Example. This means that the chemical durability of the electrolyte membrane was greatly increased by the metal-organic framework.

While the experimental examples and embodiments of the present disclosure have been described in detail above, the scope of the patent right of the present disclosure is not limited thereto, but various modifications and improvements which could be made by those skilled in the art using the basic concept of the present disclosure defined in the following claims would also fall within the scope of the patent right of the present disclosure.

What is claimed is:

1. An electrolyte membrane for a membrane-electrode assembly comprising:
an ionomer; and
a metal-organic framework (MOF) comprising a first metal ion and an organic ligand.

2. The electrolyte membrane of claim 1,
wherein the ionomer comprises a perfluorinated sulfonic acid-based polymer.

3. The electrolyte membrane of claim 1,
wherein the first metal ion comprises tin ions (Sn²⁺), zinc ions (Zn²⁺), manganese ions (Mn²⁺), or combinations thereof.

4. The electrolyte membrane of claim 1,
wherein the organic ligand comprises an imidazole-based compound.

5. The electrolyte membrane of claim 1,
wherein the metal-organic framework is represented by Formula 1 below:

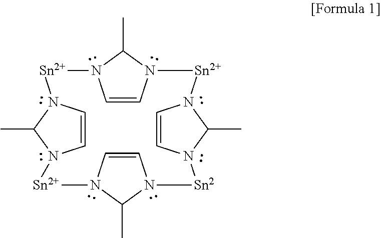

6. The electrolyte membrane of claim 1,
wherein the metal-organic framework further comprises a second metal ion located in an inner space of the metal-organic framework.

7. The electrolyte membrane of claim 6,
wherein the second metal ion comprises trivalent cerium ions (Ce³⁺), tetravalent cerium ions (Ce⁴⁺), or combinations thereof.

8. The electrolyte membrane of claim 6,
wherein a weight ratio of the first metal ion and the second metal ion is about 1:1 to 20:1.

9. The electrolyte membrane of claim 6,
wherein the metal-organic framework is represented by Formula 2 below:

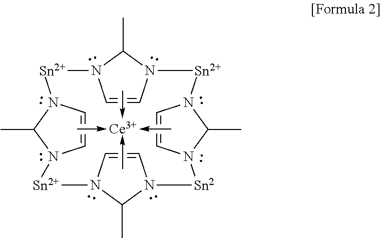

10. The electrolyte membrane of claim 1,
wherein the electrolyte membrane comprises the metal-organic framework in an amount of about 0.01 wt % to 20 wt % based on the total weight of the electrolyte membrane.

11. A membrane-electrode assembly comprising:
an electrolyte membrane according to claim 1;
a cathode disposed on one surface of the electrolyte membrane; and
an anode disposed on another surface of the electrolyte membrane.

12. A method for preparing an electrolyte membrane for a membrane-electrode assembly comprising:
preparing a first solution comprising a precursor of a first metal ion;
preparing a second solution comprising a precursor of an organic ligand;
obtaining an admixture comprising the first solution and the second solution;
agitating the admixture to precipitate a metal-organic framework in which the first metal ion and the organic ligand are coordinated;
preparing a dispersion comprising the metal-organic framework and an ionomer; and
preparing the electrolyte membrane by applying the dispersion on a substrate.

13. The method of claim 12,
wherein the first metal ion comprises tin ions (Sn²⁺), zinc ions (Zn²⁺), manganese ions (Mn²⁺) or combinations thereof, and
wherein the organic ligand comprises an imidazole-based compound.

14. The method of claim 12,
wherein the admixture is agitated at a temperature of about 50° C. to 150° C. for about 1 hour to 24 hours to precipitate the metal-organic framework.

15. The method of claim 12,
wherein the metal-organic framework is represented by Formula 1 below:

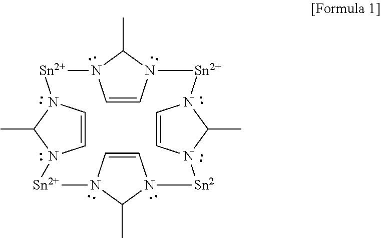

16. The method of claim 12,
wherein a third solution comprising a precursor of a second metal ion is added to the admixture and agitated to precipitate a metal-organic framework, in whose inner space the second metal ion is located.

17. The method of claim 16,
wherein the second metal ion comprises trivalent cerium ions (Ce³⁺), tetravalent cerium ions (Ce⁴⁺) or combinations thereof.

18. The method of claim 16,
wherein a weight ratio of the first metal ion and the second metal ion is about 1:1 to 20:1.

19. The method of claim 16,
wherein the metal-organic framework is represented by Formula 2 below:

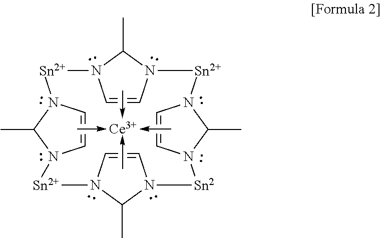

20. The method of claim 12,
wherein the electrolyte membrane comprises the metal-organic framework in an amount of about 0.01 wt % to 20 wt % based on the total weight of the electrolyte membrane.
